(19) United States
(12) Patent Application Publication
(10) Pub. No.: US 2014/0074320 A1
(43) Pub. Date: Mar. 13, 2014

(54) VEHICLE REMOTE CONTROL SYSTEM, REMOTE CONTROL TERMINAL, SERVER, AND VEHICLE

(71) Applicant: Junichi Nishida, Miyoshi-shi (JP)

(72) Inventor: Junichi Nishida, Miyoshi-shi (JP)

(73) Assignee: TOYOTA JIDOSHA KABUSHIKI KAISHA, Toyota-shi, Aichi (JP)

(21) Appl. No.: 14/110,822

(22) PCT Filed: May 18, 2011
(86) PCT No.: PCT/JP2011/061438

§ 371 Date: Oct. 9, 2013

(51) Int. Cl. G06F 7/00

(52) U.S. Cl. CPC G06F 7/00
USPC 701/2

(57) ABSTRACT

A mobile terminal transmits a timer set time set by a vehicle user and a current time to a DCM of a vehicle via a server. A charge ECU calculates a standby time based on a time difference between the timer set time and the current time, and starts battery charge when the standby time has elapsed. This configuration uses no on-vehicle clock, and hence the battery charge can be performed at a time intended by the vehicle user. Further, the server calculates a charge start estimated time based on a current standby time reported from the DCM and a current time in an area where the vehicle is located, and transmits the charge start estimated time to the mobile terminal.

### TECHNICAL FIELD

The present invention relates to a vehicle remote control system for controlling an on-vehicle device to execute a predetermined operation at a preset time by presetting the time via a remote control terminal.

### BACKGROUND ART

Hitherto, there has been known a remote control system for remotely controlling an operation of an on-vehicle device by operating a remote control terminal at a position away from a vehicle. For example, Patent Literature 1 proposes a system for controlling an operation for charging a battery or an operation of an air conditioner mounted in an electric vehicle by a remote control command. In the system proposed in Patent Literature 1, the setting of a timer can also be performed by remote control.

### CITATION LIST

### Patent Literature

[PTL 1] JP 08-149608 A

### SUMMARY OF INVENTION

In the setting of the timer, a control system on the vehicle side includes a clock. However, the time of the clock is not always accurate. Accordingly, if the time of the clock of the vehicle control system deviates from the actual time, a requested operation cannot be started at the time intended by a vehicle user. For example, the electric charge for charging a battery can be suppressed if a night-only service is used. However, in the case where the time of the vehicle clock (referred to as “on-vehicle board clock”) deviates from the actual time, even though a charge start time is correctly set, a period of time during which the battery is actually charged may deviate from the period of time for the night-only service.

In the case where the presetting of the timer is conducted in the vehicle, no problem occurs because the vehicle user can recognize the deviation of the on-vehicle clock. However, in the case where the presetting of the timer is conducted by remote control at a position away from the vehicle, the vehicle user cannot recognize a time difference between a clock equipped in the remote control terminal and the on-vehicle clock. Thus, the above-mentioned problem occurs. Further, in a country where a plurality of standard times are set or in a country where a summer time system is adopted, a large time difference may occur between the clock equipped in the remote control device and the on-vehicle clock.

The present invention has been made for dealing with the above-mentioned problem, and it is an object thereof to enable an on-vehicle device to execute a predetermined operation at a timing intended by a vehicle user even when the presetting of a timer is conducted by remote control.

In order to achieve the above-mentioned object, the present invention has the following feature. Specifically, there is provided a vehicle remote control system for transmitting a setting command relating to a preset time set by a remote control terminal (300) to an on-vehicle communication device (150) of a vehicle identified by the remote control terminal via a server (210) provided in an information center (200) that handles vehicle information, thereby controlling an on-vehicle device (180) provided in the vehicle to execute a predetermined operation at the preset time, the vehicle remote control system including: standby time calculation means (S32) for calculating a standby time (Tx) until the on-vehicle device (180) is controlled to execute the predetermined operation based on the preset time (Tset) set by the remote control terminal and a current time (Tter) of a clock included in the remote control terminal; and operation timing setting means (S33 to S36) for setting an operation timing of the on-vehicle device so that the on-vehicle device executes the predetermined operation when the standby time calculated by the standby time calculation means elapses.

In this case, the standby time calculation means may calculate, as the standby time, a time corresponding to a difference between the preset time set by the remote control terminal and the current time of the clock included in the remote control terminal.

According to the present invention, the vehicle user operates the remote control terminal to set a preset time at which the on-vehicle device is controlled to execute a predetermined operation. The preset time is not limited to an operation start time of the on-vehicle device, and may be an operation end time of the on-vehicle device. In the case where the time at which the on-vehicle device is operated is controlled based on an on-vehicle clock, if the time of the on-vehicle clock deviates from the time of the remote control terminal, the on-vehicle device cannot be activated at a time intended by the vehicle user. To deal with this, the vehicle remote control system according to the present invention includes the standby time calculation means and the operation timing setting means.

The standby time calculation means calculates the standby time until the on-vehicle device is controlled to execute the predetermined operation based on the preset time set by the remote control terminal and the current time of the clock included in the remote control terminal. The standby time can be calculated as a time corresponding to a difference between the preset time set by the remote control terminal and the current time of the clock included in the remote control terminal.

The operation timing setting means sets the operation timing of the on-vehicle device so that the on-vehicle device executes the predetermined operation when the standby time calculated by the standby time calculation means elapses. In this way, the operation timing of the on-vehicle device is set with reference to the clock of the remote control terminal. Therefore, the operation timing of the on-vehicle device is not determined based on the on-vehicle clock, and hence, even when the time of the on-vehicle clock differs significantly from the time of the clock of the remote control terminal, there is no problem that an activation timing of the on-vehicle device deviates. Consequently, the on-vehicle device can be operated at a timing intended by the vehicle user.

The present invention has another feature in that the vehicle remote control system further includes: actual standby time calculation means (S35) for calculating an actual standby time by reducing the standby time calculated by the standby time calculation means with a lapse of time; estimated time calculation means (S58) for calculating an estimated time at which the on-vehicle device is controlled to execute the predetermined operation based on the actual standby time calculated by the actual standby time calculation means and a current time in an area where the vehicle is located; and display control means (S60) for displaying the estimated time calculated by the estimated time calculation means on a screen of the remote control terminal.

In this case, the estimated time calculation means may calculate, as the estimated time, a time obtained by advancing the current time in the area where the vehicle is located by the actual standby time calculated by the actual standby time calculation means.

According to the present invention, the vehicle remote control system includes the actual standby time calculation means, the estimated time calculation means, and the display control means in order for the vehicle user to confirm the presetting by the remote control terminal after the preset time at which the on-vehicle device is activated is set. The actual standby time calculation means calculates the actual standby time by reducing the standby time calculated by the standby time calculation means with a lapse of time. Specifically, the actual standby time as a standby time at the current time point is calculated by reducing the elapsed time from an initially set standby time.

The estimated time calculation means calculates the estimated time at which the on-vehicle device is controlled to execute the predetermined operation based on the actual standby time calculated by the actual standby time calculation means and the current time in the area where the vehicle is located. The estimated time may be calculated as a time obtained by advancing the current time in the area where the vehicle is located by the actual standby time calculated by the actual standby time calculation means.

In this case, in the case where this system is used in a situation in which standard time at the position of the vehicle differs depending on the position of the vehicle, for example, vehicle position detection means for detecting the position of the vehicle is provided, and the time in standard time corresponding to the detected position of the vehicle may be set as the current time in the area where the vehicle is located. On the other hand, in the case where it is known in advance that this system is used in a situation in which standard time does not change depending on the position of the vehicle, it is not necessary to detect the position of the vehicle, but it is only necessary to set the current time in predetermined standard time as the current time in the area where the vehicle is located.

The display control means displays the estimated time calculated by the estimated time calculation means on the screen of the remote control terminal. In this way, the vehicle user can properly recognize the estimated time (the estimated time at the vehicle position) at which the on-vehicle device executes the predetermined operation.

The present invention has another feature in that the on-vehicle device is a charge device (180) for charging an on-vehicle battery (190).

According to the present invention, a charge time (charge start time or charge end time) of the on-vehicle battery can be preset by using the remote control terminal. In this case, the charge device can be operated at a timing intended by the vehicle user, and hence the battery charge using a time zone for a night-only service can be appropriately performed, for example.

The present invention can be applied to a remote control terminal for use in the vehicle remote control system, and has a feature in that the remote control terminal is configured to transmit the set preset time and the current time of the clock included in the remote control terminal to the server. Further, the present invention has another feature in that the remote control terminal includes the standby time calculation means. Further, the present invention has another feature in that the remote control terminal includes the display control means. Further, the present invention has another feature in that the remote control terminal includes the estimated time calculation means and the display control means.

In addition, the present invention further has the following feature. Specifically, there is provided a remote control terminal for transmitting a setting command relating to a preset time to an on-vehicle communication device of a specific vehicle via a server provided in an information center that handles vehicle information, thereby controlling an on-vehicle device provided in the specific vehicle to execute a predetermined operation at the preset time, the remote control terminal including: setting means for setting the preset time; clock means for outputting a current time; standby time calculation means for calculating a standby time until the on-vehicle device is controlled to execute the predetermined operation based on the preset time set by the setting means and the current time output by the clock means; and standby time transmission means for transmitting the standby time calculated by the standby time calculation means to the server, thereby setting an operation timing of the on-vehicle device.

According to the remote control terminal of the present invention, the standby time until the on-vehicle device is controlled to execute the predetermined operation is calculated and transmitted to the server, and hence, even when the time of the on-vehicle clock differs significantly from the time of the clock of the remote control terminal, there is no problem that an activation timing of the on-vehicle device deviates. Consequently, the on-vehicle device can be operated at a timing intended by the vehicle user.

Further, the present invention has another feature in that the remote control terminal further includes: actual standby time acquisition means for acquiring an actual standby time by reducing the standby time with a lapse of time; vehicle position time acquisition means for acquiring a current time in an area where the vehicle is located; estimated time calculation means for calculating an estimated time at which the on-vehicle device is controlled to execute the predetermined operation based on the actual standby time acquired by the actual standby time acquisition means and the current time in the area where the vehicle is located, which is acquired by the vehicle position time acquisition means; and estimated time display means for displaying the estimated time calculated by the estimated time calculation means.

According to the remote control terminal of the present invention, the estimated time at which the on-vehicle device is controlled to execute the predetermined operation is calculated based on the actual standby time and the current time in the area where the vehicle is located, and the calculated estimated time is displayed. Consequently, the vehicle user can properly recognize the estimated time (the estimated time at the vehicle position) at which the on-vehicle device executes the predetermined operation.

The present invention can be applied to a server for use in the vehicle remote control system, and has a feature in that the server is configured to receive the preset time set by the remote control terminal and the current time of the clock included in the remote control terminal, and to transmit the received preset time and the received current time to the on-vehicle communication device. Further, the present invention has another feature in that the server includes the standby time calculation means. Further, the present invention has another feature in that the server includes the estimated time calculation means.

In addition, the present invention further has the following feature. Specifically, there is provided a server to be provided in an information center that handles vehicle information, the server being configured to receive a setting command relating to a preset time set by a remote control terminal and to transmit a remote command for controlling an on-vehicle device provided in a vehicle specified by the remote control terminal to execute a predetermined operation at the preset time to an on-vehicle communication device of the vehicle, the server including: standby time calculation means for calculating a standby time until the on-vehicle device is controlled to execute the predetermined operation based on the preset time set by the remote control terminal and a current time of a clock included in the remote control terminal; and standby time transmission means for transmitting the standby time calculated by the standby time calculation means to the on-vehicle communication device as the remote command, thereby setting an operation timing of the on-vehicle device.

According to the server of the present invention, the standby time until the on-vehicle device is controlled to execute the predetermined operation is calculated based on the preset time set by the remote control terminal and the current time of the clock included in the remote control terminal, and the standby time is transmitted to the on-vehicle communication device as the remote command, to thereby set the operation timing of the on-vehicle device. In this way, even when the time of the on-vehicle clock differs significantly from the time of the clock of the remote control terminal, there is no problem that an activation timing of the on-vehicle device deviates. Consequently, the on-vehicle device can be operated at a timing intended by the vehicle user.

Further, the present invention has another feature in that the server further includes: actual standby time acquisition means for acquiring an actual standby time by reducing the standby time with a lapse of time; vehicle position time acquisition means for acquiring a current time in an area where the vehicle is located; estimated time calculation means for calculating an estimated time at which the on-vehicle device is controlled to execute the predetermined operation based on the actual standby time acquired by the actual standby time acquisition means and the current time in the area where the vehicle is located, which is acquired by the vehicle position time acquisition means; and estimated time transmission means for transmitting the estimated time calculated by the estimated time calculation means to the remote control terminal.

According to the server of the present invention, the estimated time at which the on-vehicle device is controlled to execute the predetermined operation is calculated based on the actual standby time and the current time in the area where the vehicle is located, and the calculated estimated time is transmitted to the remote control terminal. Consequently, the vehicle user can properly recognize the estimated time (the estimated time at the vehicle position) at which the on-vehicle device executes the predetermined operation.

The present invention can be applied to a vehicle for use in the vehicle remote control system, and has a feature in that the vehicle includes the standby time calculation means and the operation timing setting means. Further, the present invention has another feature in that the vehicle includes the actual standby time calculation means.

In addition, the present invention further has the following feature. Specifically, there is provided a vehicle, which is configured to receive by an on-vehicle communication device a setting command relating to a preset time set by a remote control terminal via a server provided in an information center that handles vehicle information, thereby controlling an on-vehicle device to execute a predetermined operation at the preset time, the vehicle including: time acquisition means for acquiring the preset time set by the remote control terminal and a current time of a clock included in the remote control terminal; standby time calculation means for calculating a standby time until the on-vehicle device is controlled to execute the predetermined operation based on the preset time and the current time of the clock included in the remote control terminal, which are acquired by the time acquisition means; and operation timing setting means for setting an operation timing of the on-vehicle device so that the on-vehicle device executes the predetermined operation when the standby time calculated by the standby time calculation means elapses.

According to the vehicle of the present invention, the standby time until the on-vehicle device is controlled to execute the predetermined operation is calculated based on the preset time set by the remote control terminal and the current time of the clock included in the remote control terminal, and the on-vehicle device is controlled to execute the predetermined operation when the standby time elapses. Therefore, even when the time of the on-vehicle clock differs significantly from the time of the clock of the remote control terminal, there is no problem that an activation timing of the on-vehicle device deviates. Consequently, the on-vehicle device can be operated at a timing intended by the vehicle user.

Further, the present invention has another feature in that the vehicle further includes: actual standby time calculation means for calculating an actual standby time by reducing the standby time calculated by the standby time calculation means with a lapse of time; and actual standby time transmission means for transmitting the actual standby time calculated by the actual standby time calculation means to the server.

According to the vehicle of the present invention, the calculated actual standby time is transmitted to the server, and hence the vehicle user can properly recognize the estimated time (the estimated time at the vehicle position) at which the on-vehicle device executes the predetermined operation.

For facilitating the understanding of the invention, in the above description, the configurations of the invention corresponding to the embodiment are suffixed in parentheses with symbols used in the embodiment. However, the components of the invention are not intended to be limited to the embodiment as defined by the symbols.

### BRIEF DESCRIPTION OF DRAWINGS

FIG. 1 is a schematic configuration diagram of a vehicle information communication system to which a vehicle remote control system according to an embodiment of the present invention is applied.

FIG. 2 is a flowchart illustrating a timer charge presetting routine.

FIG. 3 is a flowchart illustrating a timer preset charge routine.

FIG. 4 is a flowchart illustrating a timer charge presetting confirmation routine.

### DESCRIPTION OF EMBODIMENT

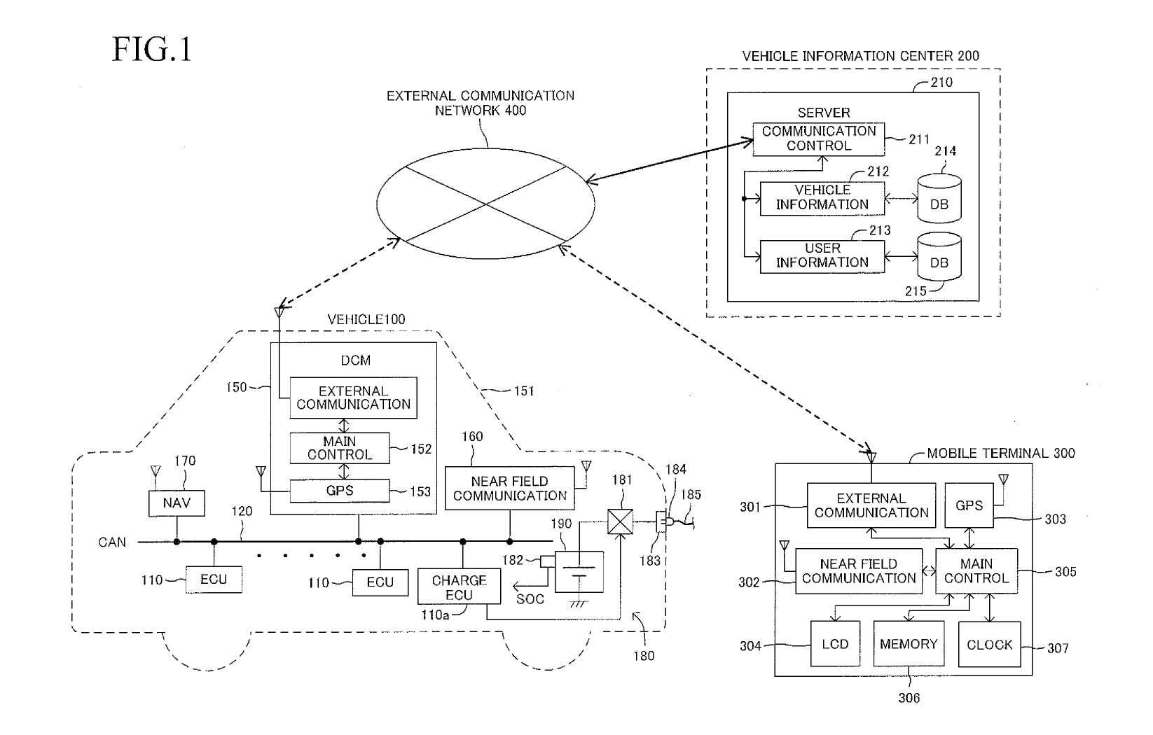

Now, a vehicle remote control system according to one embodiment of the present invention is described with reference to the drawings. FIG. 1 illustrates a vehicle information communication system. The vehicle remote control system in this embodiment is applied to this information communication system.

A vehicle 100 to which the information communication system is applied in this embodiment is an electric vehicle that drives a running motor by electric power of a battery 190 or a plug-in hybrid vehicle that includes a running motor and an internal combustion engine and is capable of charging the battery 190 serving as a power source of the running motor from an external power source.

First, a description is given of the vehicle information communication system. The vehicle information communication system organically connects the vehicle 100, a vehicle information center 200, and a mobile terminal 300 owned by a vehicle user via an external communication network 400 such as the Internet, thereby providing various kinds of services to the vehicle user. The vehicle 100 is equipped with a plurality of electronic control units 110 (hereinafter referred to as “vehicle ECUs 110”) for controlling the vehicle state. The vehicle ECUs 110 are each connected to a controller area network (CAN) communication line 120 of a CAN communication system, and are capable of transmitting and receiving various kinds of signals via the CAN communication line 120. Note that, a charge ECU 110a serving as a control part of a charge device 180 for charging the battery 190 is provided as one of the plurality of vehicle ECUs 110 connected to the CAN communication line 120. In the following, the vehicle ECU 110 and the charge ECU 110a are referred to simply as “vehicle ECU 110” when not distinguished from each other. The vehicle ECUs 110 each include a microcomputer, a memory, an input/output interface, a drive circuit for driving various kinds of actuators by inputting sensor signals, and the like.

The CAN communication line 120 is further connected to a data communication module 150 (hereinafter referred to as “DCM 150”) that is connected to the external communication network 400 to communicate to the vehicle information center 200. The DCM 150 includes an external communication control part 151 for communicating data to/from a server 210 of the vehicle information center 200 via the external communication network 400, a main control part 152 for communicating data to/from the vehicle ECU 110 via the CAN communication line 120 to acquire control information and outputting a command to the vehicle ECU 110, and a GPS unit 153 for detecting current position coordinates of the own vehicle based on radio waves from a GPS satellite. The DCM 150 includes a microcomputer as its primary part, a memory, a wireless communication circuit, an input/output interface, and the like.

The CAN communication line 120 is further connected to a near field communication control device 160 serving as a communication interface for performing near field communication to/from the mobile terminal 300. In this embodiment, Bluetooth is used as the communication scheme of the near field communication control device 160. Alternatively, however, another near field communication scheme such as Wi-Fi may be employed. The CAN communication line 120 is further connected to a navigation device 170 for guiding the vehicle to a destination. The navigation device 170 includes a vehicle position detection unit for detecting the position and running direction of the vehicle, a memory for storing various kinds of information such as map data, a microcontroller for executing an application for navigating the vehicle to the destination, a human interface constituted by a touch panel liquid crystal display and a speaker, and the like (the illustration of the respective components is omitted).

The vehicle information center 200 is a facility for acquiring various kinds of vehicle information from the vehicle 100 and providing various kinds of service information to the user. The vehicle information center 200 is equipped with the server 210 including a microcontroller as its primary part. The server 210 includes a communication control part 211 that is connected to the external communication network 400 to perform communication control, a vehicle information server 212 for managing vehicle information, a user information server 213 for managing vehicle user information, a vehicle information storage part 214 for storing a database of the vehicle information, and a user information storage part 215 for storing a database of the user information. The server 210 stores associated information that associates an ID for identifying the vehicle 100 (information corresponding to registration number or vehicle number) and an ID for identifying the vehicle user (such as user name, or e-mail address or phone number of the mobile terminal 300) with each other. Thus, when any one of the IDs is identified, the server 210 can extract information identified by the other ID. Note that, the vehicle information server 212 also has the function of remotely operating the vehicle 100 in addition to managing the vehicle information.

As the mobile terminal 300 owned by the vehicle user, for example, a mobile phone such as a smartphone is used. The mobile terminal 300 includes an external communication control part 301 serving as a communication interface for connecting to the external communication network 400, a near field communication control part 302 serving as a communication interface for performing near field communication using Bluetooth, a GPS unit 303 for detecting current position coordinates of the mobile terminal 300 based on radio waves from a GPS satellite, a touch panel liquid crystal display 304 serving as both an indicator and an operation unit, a main control part 305 including a microcomputer responsible for the communication control and the execution of various kinds of applications, a non-volatile memory 306 for storing application programs and various kinds of data, and a clock 307 for outputting current time information. The mobile terminal 300 has a telephone function, an e-mail function, a function of connecting to the Internet, and a function of executing various kinds of application programs, as well as a function of exchanging various kinds of information to/from the server 210 of the vehicle information center 200 by connection.

In this vehicle information communication system, various kinds of information relating to the vehicle 100 can be transmitted from the DCM 150 to the server 210 of the vehicle information center 200 together with the vehicle ID (information corresponding to registration number or vehicle number), and the server 210 can transmit information necessary for the vehicle user to the mobile terminal 300. For example, the DCM 150 acquires from the CAN communication line 120 information indicating the state of charge (SOC) of the battery 190 detected by the charge ECU, and periodically transmits the acquired SOC information to the server 210 of the vehicle information center 200 together with the vehicle ID and vehicle position information. In this way, the server 210 of the vehicle information center 200 can grasp the SOC of the battery 190 together with the vehicle position. When the SOC is decreasing, the server 210 searches for a charge station available within a cruising range of the vehicle 100 by using the Internet or the like, and then transmits a message for prompting the vehicle user to charge the battery to the mobile terminal 300 of the vehicle user and transmits a search result (charge station list or the like) to the mobile terminal 300 of the vehicle user.

The DCM 150 further transmits to the server 210, together with the vehicle ID and the vehicle position information, operation information including a running distance, running time, and power consumption in one section defined as a period from the turning-on of an ignition switch (or an accessary switch) to the turning-off (the one section is referred to as “one trip section”). The server 210 stores the received operation information and vehicle position information in the vehicle information storage part 214 in association with the vehicle ID. In this way, the vehicle user can acquire necessary information from the server 210 also by starting the application of the mobile terminal 300 as appropriate. For example, when the vehicle user starts the application installed on the mobile terminal 300 to request information relating to electric/fuel consumption from the server 210, the server 210 generates information corresponding to the request from the vehicle user based on the operation information stored in the vehicle information storage part 214, and transmits the generated information to the mobile terminal 300.

The vehicle user can also transmit, to the vehicle 100 side, the latest map information, facility information, and the like downloaded on the mobile terminal 300 from an Internet site, for example. In this case, the information downloaded on the mobile terminal 300 is transmitted from the near field communication control part 302 to the near field communication control device 160 of the vehicle 100 and is stored in a memory of the navigation device 170.

In the vehicle information communication system, by transmitting an operation command from the mobile terminal 300 of the vehicle user to the server 210 of the vehicle information center 200, an on-vehicle device of the vehicle 100 can be remotely operated via the server 210. One function is a timer charge remote control function. The timer charge remote control function is a function that the vehicle user uses the mobile terminal 300 to preset an activation start time (charge start time) of the charge device 180 or an activation end time (charge end time) of the charge device 180 so that the activation (charge start or charge end) of the charge device 180 is executed at the preset time.

The charge device 180 includes a charger 181 for charging the battery 190 with electric power supplied from the outside, the charge ECU 110a including a microcontroller as its primary part to control the charge of the battery 190, and an SOC sensor 182 for detecting the state of charge (SOC) of the battery 190. The charge ECU 110a controls the activation of the charger 181 based on the SOC detected by the SOC sensor 182. The vehicle 100 includes a power inlet 183, and is supplied with electric power from outside the vehicle when a plug 184 of a charge cable 185 is connected to the power inlet 183.

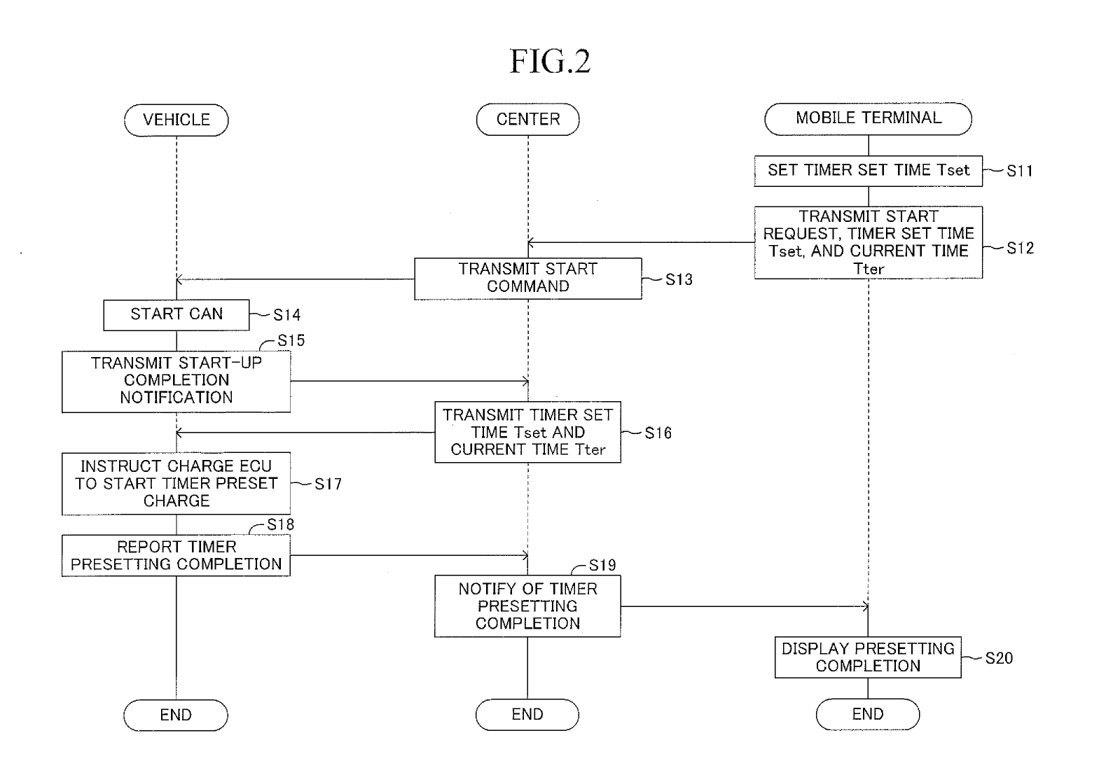

Next, a description is given of timer charge remote control. FIG. 2 is a flowchart illustrating a timer charge presetting routine. The timer charge presetting routine is performed by cooperation of the mobile terminal 300, the server 210 of the vehicle information center 200, and the DCM 150 and the charge ECU 110a of the vehicle 100.

First, the vehicle user operates the mobile terminal 300 to start up a timer charge remote control application program. The timer charge remote control application program is stored in advance in the non-volatile memory 306 of the mobile terminal 300. When the vehicle user touches a timer presetting button icon on an initial screen displayed on the timer charge remote control application, a timer presetting screen is displayed on the display 304 of the mobile terminal 300. The vehicle user inputs his/her desired charge start time on the timer presetting screen. In Step S11, the mobile terminal 300 (main control part 305) sets the charge start time input by the vehicle user as a timer set time Tset. Note that, in the following description, the main control part 305 of the mobile terminal 300 for executing the timer charge remote control application program is referred to simply as “mobile terminal 300”.

Subsequently, in Step S12, the mobile terminal 300 transmits a start request, the timer set time Tset, and a current time Tter of the mobile terminal 300 to the server 210 of the vehicle information center 200. The current time Tter is a time indicated by the clock 307 when the timer set time Tset is set by the mobile terminal 300. Note that, the mobile terminal 300 always transmits those pieces of information together with a mobile terminal ID when the mobile terminal 300 communicates to the server 210.

When the server 210 receives the start request transmitted from the mobile terminal 300, in Step S13, the server 210 transmits a start command to the DCM 150 of the vehicle 100 corresponding to the ID of the mobile terminal 300 (hereinafter referred to simply as “DCM 150”) by short message service (SMS) or voice calling. The DCM 150 starts in response to the start command transmitted from the server 210. The DCM 150 starts the CAN communication system in Step S14, and transmits a start-up completion report to the server 210 by Hypertext Transfer Protocol (HTTP) communication in Step S15. The HTTP is used for subsequent communication between the DCM 150 and the server 210.

In Step S16, the server 210 transmits the timer set time Tset set by the mobile terminal 300 and the current time Tter to the DCM 150. When the DCM 150 receives the timer set time Tset and the current time Tter transmitted from the server 210, in Step S17, the DCM 150 transmits the timer set time Tset and the current time Tter to the charge ECU 110a to control the charge ECU 110a to start timer preset charge processing. The timer preset charge processing executed by the charge ECU 110a is described later.

After the DCM 150 transmits the timer set time Tset and the current time Tter to the charge ECU 110a to start the timer preset charge processing, in Step S18, the DCM 150 transmits a timer presetting completion report to the server 210. When the server 210 receives the timer presetting completion report from the DCM 150, in Step S19, the server 210 transmits a timer presetting completion notification to the mobile terminal 300 by Hypertext Transfer Protocol over Secure Socket Layer (HTTPS) communication. When the mobile terminal 300 receives the timer presetting completion notification from the server 210, in Step S20, the mobile terminal 300 displays a message indicating the completion of the timer presetting on the timer presetting screen displayed on the display 304, and ends the timer charge remote control application.

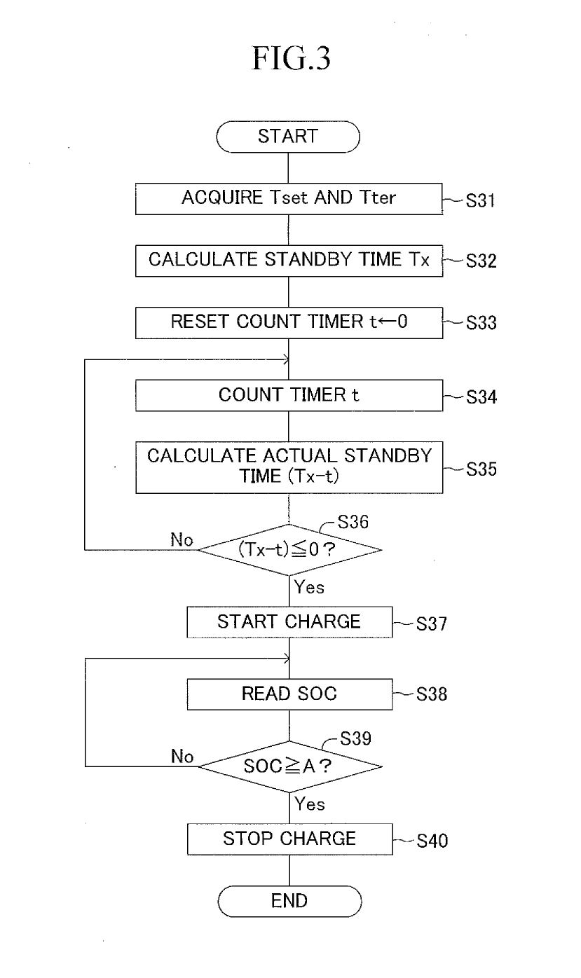

FIG. 3 is a flowchart illustrating a timer preset charge routine executed by the charge ECU 110a. When receiving an instruction of starting the timer preset charge processing from the DCM 150 (Step S17), the charge ECU 110a starts the timer preset charge routine. First, in Step S31, the charge ECU 110a acquires the timer set time Tset and the current time Tter transmitted from the DCM 150. Subsequently, in Step S32, the charge ECU 110a subtracts the current time Tter from the timer set time Tset (Tset-Tter), thereby calculating a standby time Tx until the start of charge, which indicates how many minutes remain from the timer set time Tset before the start of charge.

Subsequently, in Step S33, the charge ECU 110a resets a count value t of a count timer (t=0). Subsequently, in Step S34, the charge ECU 110a starts to count (increment) the count timer, and in Step S35, the charge ECU 110a calculates a current actual standby time (Tx-t), which is a value obtained by subtracting the count value t (indicating an elapsed time) of the count timer from the standby time Tx. Subsequently, in Step S36, the charge ECU 110a determines whether or not the current actual standby time (Tx-t) has reached zero. In other words, the charge ECU 110a determines whether or not the standby time Tx has elapsed since the start of the counting of the count timer. The charge ECU 110a repeats the processing of Steps S34 to S36 until the actual standby time (Tx-t) reaches zero.

Then, when the lapse of the standby time Tx is detected (S36: Yes), in Step S37, the charge ECU 110a starts to drive the charger 181 to charge the battery 190. Subsequently, in Step S38, the charge ECU 110a reads the SOC detected by the SOC sensor 182, and in Step S39, the charge ECU 110a continues the charge until the SOC reaches a preset set value A. When the SOC reaches the set value A, in Step S40, the charge ECU 110a stops the activation of the charger 181 to finish the timer preset charge routine. Note that, the battery charge is stopped, for example, when the vehicle user performs an arbitrary charge stop operation or when a charge end timing comes in a situation where the end of charge is preset.

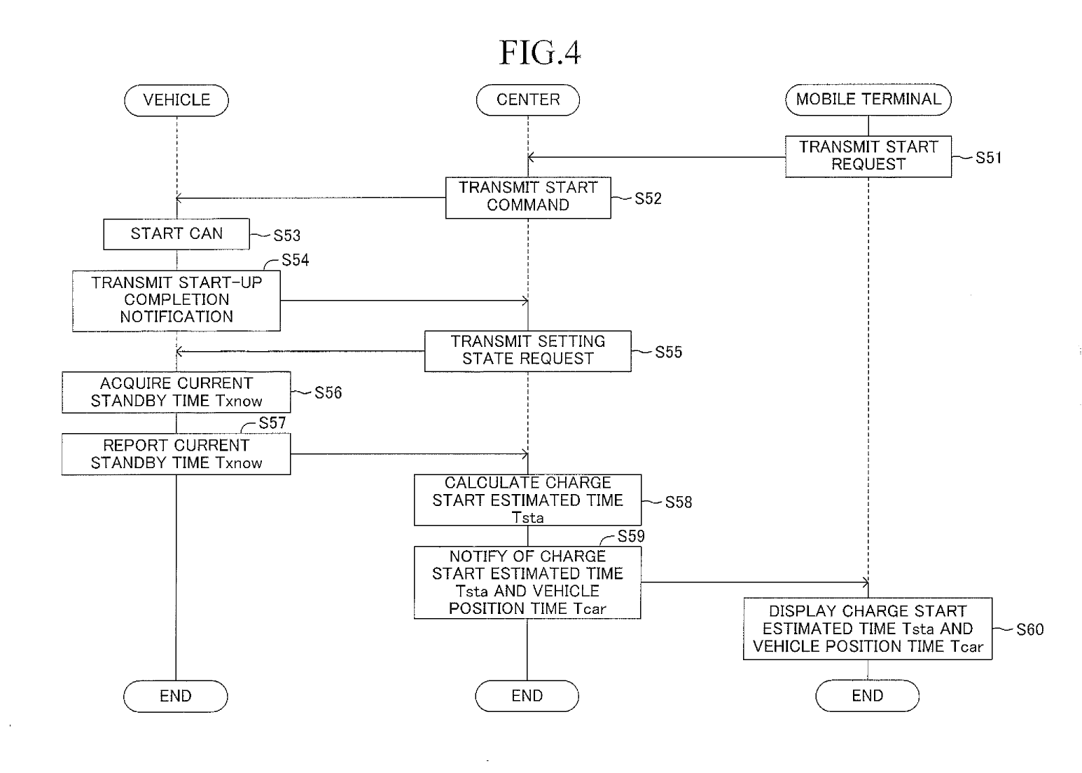

Next, a description is given of processing for confirming a timer presetting status by the vehicle user. FIG. 4 is a flowchart illustrating a timer charge presetting confirmation routine. The timer charge presetting confirmation routine is performed by cooperation of the mobile terminal 300, the server 210 of the vehicle information center 200, and the DCM 150 and the charge ECU 110a of the vehicle 100.

First, the vehicle user operates the mobile terminal 300 to start up a timer charge remote control application, and touches a timer presetting confirmation button icon on an initial screen displayed on the timer charge remote control application. In response thereto, in Step S51, the mobile terminal 300 transmits a start request to the server 210 of the vehicle information center 200.

When the server 210 receives the start request transmitted from the mobile terminal 300, in Step S52, the server 210 transmits a start command to the DCM 150 of the vehicle 100. The DCM 150 starts in response to the start command transmitted from the server 210. The DCM 150 starts the CAN communication system in Step S53, and transmits a start-up completion report to the server 210 in Step S54.

When the server 210 receives the start-up completion report, in Step S55, the server 210 transmits a setting state request to the DCM 150. When the DCM 150 receives the setting state request, in Step S56, the DCM 150 requests a current standby time Txnow from the charge ECU 110a. As described above, after the standby time Tx is set, the charge ECU 110a activates the count timer to count the elapsed time (timer value t), thereby calculating the actual standby time (Tx-t) (S35). The actual standby time (Tx-t) corresponds to the current standby time Txnow. Accordingly, the charge ECU 110a follows the request from the DCM 150 to transmit the actual standby time (Tx-t) calculated in Step S35 to the DCM 150 as the current standby time Txnow.

Subsequently, in Step S57, the DCM 150 transmits to the server 210 a report of the current standby time Txnow transmitted from the charge ECU 110a. Note that, when the presetting of the timer has not been conducted, the DCM 150 transmits a report indicating this state.

When the server 210 receives the report of the current standby time Txnow, in Step S58, the server 210 calculates a time to start the battery charge (a time in an area where the vehicle 100 is located) based on the current standby time Txnow and the current time in the area where the vehicle 100 is located. The vehicle position information is transmitted from the DCM 150 to the server 210 together with the operation information in one trip section and the vehicle ID each time the ignition switch (or the accessary switch) of the vehicle 100 is switched from the on state to the off state, and is stored in the vehicle information storage part 214. Accordingly, the server 210 reads the latest vehicle position information of the vehicle 100 from the vehicle information storage part 214, and uses standard time in the area where the vehicle 100 is located to calculate the current time at the vehicle position.

For example, the server 210 stores a map in which the vehicle position and standard time are associated with each other (for example, in the vehicle information storage part 214), and uses the map to determine standard time used at the vehicle position. The server 210 includes an accurate clock (not shown), and calculates a current time at the vehicle position based on the current time output from the clock and the standard time used at the vehicle position. Note that, in the case where it is known in advance that this system is used in a situation in which standard time does not change depending on the position of the vehicle 100, it is not necessary to calculate the current time based on the position of the vehicle 100, but it is only necessary to set the current time in predetermined standard time as the current time in the area where the vehicle is located.

The server 210 adds the current standby time Txnow to the time at the vehicle position obtained when the report of the current standby time Txnow is received (referred to as “vehicle position time Tcar”) (Tcar+Txnow), thereby calculating a charge start estimated time Tsta. In other words, the server 210 sets a time obtained by advancing the vehicle position time Tcar by the current standby time Txnow as the charge start estimated time Tsta. Subsequently, in Step S59, the server 210 transmits a notification of the charge start estimated time Tsta and the vehicle position time Tcar to the mobile terminal 300.

When the mobile terminal 300 receives the notification of the charge start estimated time Tsta and the vehicle position time Tcar, in Step S60, the mobile terminal 300 displays and arranges the charge start estimated time Tsta and the vehicle position time Tcar on the display 304. Then, when the vehicle user touches a confirmation end button icon displayed on the display 304, the mobile terminal 300 ends the timer charge remote control application program.

Note that, in the above description, the timer presetting processing (FIG. 2) has been described first for describing the standby time Tx, but in the presetting of the timer, the report of the timer presetting status illustrated in FIG. 4 may be performed first. In this case, in the timer presetting processing, it is not necessary to issue the start request, but it is only necessary to preset the timer after the report of the timer presetting status without any further processing.

According to the vehicle remote control system in this embodiment described above, when the vehicle user operates the mobile terminal 300 to set the timer set time Tset indicating a preset time of the battery charge, the standby time Tx at that time point is calculated based on the current time Tter indicated by the clock 307 of the mobile terminal 300 at the time of the setting and the timer set time Tset. Then, when the lapse of the standby time Tx is detected by the count timer, the battery charge is started. Accordingly, the on-vehicle clock equipped in the vehicle 100 is not used, and hence the battery charge can be started at a timing intended by the vehicle user regardless of the time of the on-vehicle clock. Consequently, even when the time of the on-vehicle clock differs significantly from the time of the clock 307 of the mobile terminal 300, the timer charge can be appropriately performed.

In the case where the vehicle user confirms the timer presetting status, the current standby time Txnow (=actual standby time) is calculated by subtracting the elapsed time detected by the count timer from the standby time Tx, and the charge start estimated time Tsta is calculated based on the current standby time Txnow and the vehicle position time Tcar and is displayed on the display 304 of the mobile terminal 300. Accordingly, the vehicle user can properly know the timer preset time at the vehicle position even at a position away from the vehicle 100. Further, the vehicle position time Tcar as well as the charge start estimated time Tsta is displayed on the display 304, and hence this configuration is effective for, for example, a country where a plurality of kinds of standard time are set or a country where a summer time system is adopted. Consequently, the vehicle user can appropriately perform the battery charge using the time zone for the night-only service in the area where the vehicle is located.

In the above, the vehicle remote control system in this embodiment has been described, but the present invention is not limited to the above-mentioned embodiment, and various changes are may be made thereto without departing from the object of the present invention.

For example, in this embodiment, in Steps S59 and S60 of the timer charge presetting confirmation routine, the vehicle position time Tcar is transmitted from the server 210 to the mobile terminal 300 and is displayed on the display 304 of the mobile terminal 300. Alternatively, however, the vehicle position time Tcar may not be displayed.

In this embodiment, the calculation of the standby time Tx is performed in the charge ECU 110a (S32), but the calculation of the standby time Tx may be performed in the server 210. In this case, in Step S16, the server 210 calculates the standby time Tx based on the timer set time Tset and the current time Tter, and transmits the standby time Tx as a result of the calculation to the DCM 150.

Alternatively, the calculation of the standby time Tx may be performed in the DCM 150. In this case, in Step S17, the DCM 150 calculates the standby time Tx based on the timer set time Tset and the current time Tter received from the server 210, and transmits the standby time Tx as a result of the calculation to the charge ECU 110a. When the charge ECU 110a acquires the standby time Tx transmitted from the DCM 150, the charge ECU 110a starts the processing from Step S33 in the timer preset charge routine of FIG. 3.

Still alternatively, the calculation of the standby time Tx may be performed in the mobile terminal 300. In this case, in Step S12, the mobile terminal 300 calculates the standby time Tx based on the timer set time Tset set by the vehicle user and the current time Tter indicated by the clock 307, and transmits the standby time Tx as a result of the calculation to the server 210 together with the start request. Then, in Step S16, the server 210 transmits the standby time Tx to the charge ECU 110a via the DCM 150, and the charge ECU 110a starts the processing from Step S33 in the timer preset charge routine of FIG. 3.

In this embodiment, the calculation of the charge start estimated time Tsta is performed in the server 210 (S58), but the calculation of the charge start estimated time Tsta may be performed in the mobile terminal 300. For example, the server 210 acquires the vehicle position time Tcar in Step S58, and performs processing of transmitting the current standby time Txnow transmitted from the DCM 150 and the vehicle position time Tcar to the mobile terminal 300 in Step S59. Then, in Step S60, the mobile terminal 300 receives the current standby time Txnow and the vehicle position time Tear, calculates the charge start estimated time Tsta based on the current standby time Txnow and the vehicle position time Tcar, and displays the vehicle position time Tcar and the charge start estimated time Tsta. Alternatively, the current standby time Txnow may be calculated and acquired by the mobile terminal 300.

The charge start estimated time Tsta may be displayed on the mobile terminal 300 together with a charge end predicted time Tend. In this case, for example, the charge ECU 110a estimates a necessary charge time based on the SOC detected by the SOC sensor 182, and transmits the necessary charge time to the DCM 150. In Step S57, the DCM 150 transmits a report indicating that the necessary charge time is included in the current standby time Txnow to the server 210. In Step S58, the server 210 calculates the charge start estimated time Tsta, and also calculates the charge end predicted time Tend by adding the necessary charge time to the charge start estimated time Tsta. Then, in Step S59, the server 210 transmits a notification of the charge start estimated time Tsta, the vehicle position time Tcar, and the charge end predicted time Tend to the mobile terminal 300. In Step S60, the mobile terminal 300 displays and arranges the charge start estimated time Tsta, the vehicle position time Tcar, and the charge end predicted time Tend on the display 304. Note that, in this case, the calculation of the charge end predicted time Tend may not be performed in the server 210, but be calculated in the mobile terminal 300 by the server 210 transmitting the necessary charge time to the mobile terminal 300.

In this embodiment, a description has been given of the processing of presetting and setting the start time of the battery charge. However, also in the case where processing of presetting an end time of the battery charge is performed, similarly to the embodiment, the standby time Tx is calculated, and the battery charge is finished based on the lapse of the standby time Tx. Alternatively, also in the case where processing of confirming a status of presetting the end of the battery charge is performed, similarly to the embodiment, the current standby time Txnow is calculated, and the current standby time Txnow is added to the vehicle position time Tcar to calculate a charge end estimated time.

In this embodiment, a description has been given of the remote control system for presetting the charge of the battery 190. However, the present invention is not limited to the presetting of the battery charge. For example, in a pre-air conditioning remote control system for remotely operating an air conditioner of the vehicle so as to activate the air conditioner before an occupant rides on the vehicle, the present invention is applicable also to a system for presetting and setting a start time of pre-air conditioning.

1. A vehicle remote control system for transmitting a setting command relating to a preset time set by a remote control terminal to an on-vehicle communication device of a vehicle identified by the remote control terminal via a server provided in an information center that handles vehicle information, thereby controlling an on-vehicle device provided in the vehicle to execute a predetermined operation at the preset time, the vehicle remote control system comprising:
standby time calculation means for calculating a standby time until the on-vehicle device is controlled to execute the predetermined operation based on the preset time set by the remote control terminal and a current time of a clock included in the remote control terminal; and
operation timing setting means for setting an operation timing of the on-vehicle device so that the on-vehicle device executes the predetermined operation when the standby time calculated by the standby time calculation means elapses.

2. A vehicle remote control system according to claim 1, further comprising:
actual standby time calculation means for calculating an actual standby time by reducing the standby time calculated by the standby time calculation means with a lapse of time;
estimated time calculation means for calculating an estimated time at which the on-vehicle device is controlled to execute the predetermined operation based on the actual standby time calculated by the actual standby time calculation means and a current time in an area where the vehicle is located; and
display control means for displaying the estimated time calculated by the estimated time calculation means on a screen of the remote control terminal.

3. A vehicle remote control system according to claim 1, wherein the standby time calculation means calculates, as the standby time, a time corresponding to a difference between the preset time set by the remote control terminal and the current time of the clock included in the remote control terminal.

4. A vehicle remote control system according to claim 2, wherein the estimated time calculation means calculates, as the estimated time, a time obtained by advancing the current time in the area where the vehicle is located by the actual standby time calculated by the actual standby time calculation means.

5. A vehicle remote control system according to claim 1, wherein the on-vehicle device comprises a charge device for charging an on-vehicle battery.

6. A remote control terminal for use in the vehicle remote control system according to claim 1,
the remote control terminal being configured to transmit the set preset time and the current time of the clock included in the remote control terminal to the server.

7. A remote control terminal for use in the vehicle remote control system according to claim 1,
the remote control terminal comprising the standby time calculation means.

8. A remote control terminal for use in the vehicle remote control system according to claim 2,
the remote control terminal comprising the display control means.

9. A remote control terminal for use in the vehicle remote control system according to claim 2,
the remote control terminal comprising the estimated time calculation means and the display control means.

10. A remote control terminal for transmitting a setting command relating to a preset time to an on-vehicle communication device of a specific vehicle via a server provided in an information center that handles vehicle information, thereby controlling an on-vehicle device provided in the specific vehicle to execute a predetermined operation at the preset time, the remote control terminal comprising:
setting means for setting the preset time;
clock means for outputting a current time;
standby time calculation means for calculating a standby time until the on-vehicle device is controlled to execute the predetermined operation based on the preset time set by the setting means and the current time output by the clock means; and
standby time transmission means for transmitting the standby time calculated by the standby time calculation means to the server, thereby setting an operation timing of the on-vehicle device.

11. A remote control terminal according to claim 10, further comprising:
actual standby time acquisition means for acquiring an actual standby time by reducing the standby time with a lapse of time;
vehicle position time acquisition means for acquiring a current time in an area where the vehicle is located;
estimated time calculation means for calculating an estimated time at which the on-vehicle device is controlled to execute the predetermined operation based on the actual standby time acquired by the actual standby time acquisition means and the current time in the area where the vehicle is located, which is acquired by the vehicle position time acquisition means; and
estimated time display means for displaying the estimated time calculated by the estimated time calculation means.

12. A server for use in the vehicle remote control system according to claim 1,
the server being configured to receive the preset time set by the remote control terminal and the current time of the clock included in the remote control terminal, and to transmit the received preset time and the received current time to the on-vehicle communication device.

13. A server for use in the vehicle remote control system according to claim 1,
the server comprising the standby time calculation means.

14. A server for use in the vehicle remote control system according to claim 2,
the server comprising the estimated time calculation means.

15. A server to be provided in an information center that handles vehicle information, the server being configured to receive a setting command relating to a preset time set by a remote control terminal and to transmit a remote command for controlling an on-vehicle device provided in a vehicle specified by the remote control terminal to execute a predetermined operation at the preset time to an on-vehicle communication device of the vehicle, the server comprising:
standby time calculation means for calculating a standby time until the on-vehicle device is controlled to execute the predetermined operation based on the preset time set by the remote control terminal and a current time of a clock included in the remote control terminal; and
standby time transmission means for transmitting the standby time calculated by the standby time calculation means to the on-vehicle communication device as the remote command, thereby setting an operation timing of the on-vehicle device.

16. A server according to claim 15, further comprising:
actual standby time acquisition means for acquiring an actual standby time by reducing the standby time with a lapse of time;
vehicle position time acquisition means for acquiring a current time in an area where the vehicle is located;
estimated time calculation means for calculating an estimated time at which the on-vehicle device is controlled to execute the predetermined operation based on the actual standby time acquired by the actual standby time acquisition means and the current time in the area where the vehicle is located, which is acquired by the vehicle position time acquisition means; and
estimated time transmission means for transmitting the estimated time calculated by the estimated time calculation means to the remote control terminal.

17. A vehicle for use in the vehicle remote control system according to claim 1,
the vehicle comprising the standby time calculation means and the operation timing setting means.

18. A vehicle for use in the vehicle remote control system according to claim 2,
the vehicle comprising the actual standby time calculation means.

19. A vehicle, which is configured to receive by an on-vehicle communication device a setting command relating to a preset time set by a remote control terminal via a server provided in an information center that handles vehicle information, thereby controlling an on-vehicle device to execute a predetermined operation at the preset time, the vehicle comprising:
time acquisition means for acquiring the preset time set by the remote control terminal and a current time of a clock included in the remote control terminal;
standby time calculation means for calculating a standby time until the on-vehicle device is controlled to execute the predetermined operation based on the preset time and the current time of the clock included in the remote control terminal, which are acquired by the time acquisition means; and
operation timing setting means for setting an operation timing of the on-vehicle device so that the on-vehicle device executes the predetermined operation when the standby time calculated by the standby time calculation means elapses.

20. A vehicle according to claim 19, further comprising:
actual standby time calculation means for calculating an actual standby time by reducing the standby time calculated by the standby time calculation means with a lapse of time; and
actual standby time transmission means for transmitting the actual standby time calculated by the actual standby time calculation means to the server.
